(19) United States
(12) Patent Application Publication
(10) Pub. No.: US 2005/0023972 A1
(43) Pub. Date: Feb. 3, 2005

(54) Method for printing electroluminescent lamps

(76) Inventors: Mark A. Lewandowski, Marysville, MI (US); Jeffrey Michael Parker, East China Township, MI (US); Daniel J. Fenner, St. Clair, MI (US)

Correspondence Address: Charles W. Almer;National Starch and Chemical, 10 Finderne Avenue, Bridgewater, NJ, 08807, US

(21) Appl. No.: 10/629,467

(22) Filed: Jul. 29, 2003

(51) Int. Cl. H01J 1/62

(52) U.S. Cl. 313/509

(57) ABSTRACT

A method for screen or rotary screen printing EL lamps comprising front and rear electrodes, a phosphor layer and a dielectric layer. The layers are arranged in a pyramidal shape such that the front electrode has the largest dimensions and the rear electrode has the smallest dimensions. The phosphor layer and dielectric layer have smaller dimensions than the front electrode and the same or different dimensions as each other. The rear electrode has smaller dimensions than the dielectric layer. Preferably, the phosphor layer is screen printed on the front electrode before the front electrode is cured. Preferably, the dielectric comprises an ultraviolet curable solvent-based hybrid ink.

### FIELD OF THE INVENTION

The present invention relates to a method for printing electroluminescent lamps.

### BACKGROUND OF THE INVENTION

Electroluminescent (EL) lamps are thin, electrically stable parallel plate capacitors in which plates are positioned on either side of phosphor and dielectric layers. EL lamps are often less than 30 thousandths of an inch thick. In early EL lamps the plates consisted of glass and ceramic, but have evolved into the plastic thick film plates that are commonly utilized today. The multi-layer structure of the EL lamp requires that the phosphor be excited with an alternating current to generate the field effect to energize the phosphor. Energy thus generated escapes in the form of monochromatic light. In order to allow the light generated by the phosphor to escape, at least one of the plates must be at least semi-transparent. The phosphor layer of the EL lamp is raised in energy at the instigation of the first positive half cycle and then, during the latter stages of that half cycle, the electrons surrounding the phosphor atom return to their previous state, expelling their raised energy in the form of light. A similar process is repeated during the negative half-cycle of the drive field waveform. EL lamps are utilized in a wide variety of applications, including watches, pagers, membrane keyboards, sports shoes, safety vests, point of sale signs, vehicles, aircraft and military equipment.

In designing a multi-layer EL lamp several electrical and aesthetic aspects must be considered. Electrically, the design of the lamp must allow for a connection interface suitable for the product in which the lamp is to be utilized. Further, the internal layers of the lamp must be safe from shorting when powered with the correct voltage and frequency. Aesthetically, the design must fulfill the requirement of adequate illumination in a manner that is pleasing to the eye. For example, in the case of using an EL lamp to backlight an LCD, sufficient light output must be provided to maintain the contrast ratio on the display so that it is easily detectable in any ambient lighting condition. In the case that an EL lamp is utilized to backlight a membrane keyboard, both color and light position are important in order to allow the user of the keyboard to distinguish key colors and legends.

Currently, EL lamps contain dielectrics that require two or three layers, resulting in thicker lamps and higher production costs. The solvents that are required for these lamps often cause short circuit problems when in contact with the underlying inks. Further, these existing lamps require high amperage draws, contain high levels of volatile organic components, and have long cure times. It would be advantageous to provide a dielectric that would address these issues.

### SUMMARY OF THE INVENTION

The present invention is a method for printing EL lamps comprising front and rear electrodes, a phosphor layer and a dielectric layer. The layers are arranged in a pyramidal shape such that the front electrode has the largest dimensions and the rear electrode has the smallest dimensions. The phosphor layer and dielectric have smaller dimensions than the front electrode layer and the same or different dimensions as each other. The rear electrode has smaller dimensions than the dielectric layer. Preferably, the phosphor layer is printed on the front electrode before the front electrode is cured. In a preferred embodiment, the dielectric comprises an ultraviolet curable solvent-based hybrid ink.

### BRIEF DESCRIPTION OF THE DRAWINGS

FIG. 1 is a top view of an EL lamp structure.

FIG. 2 is a side view of an EL-lamp structure.

### DETAILED DESCRIPTION OF THE PREFERRED EMBODIMENTS

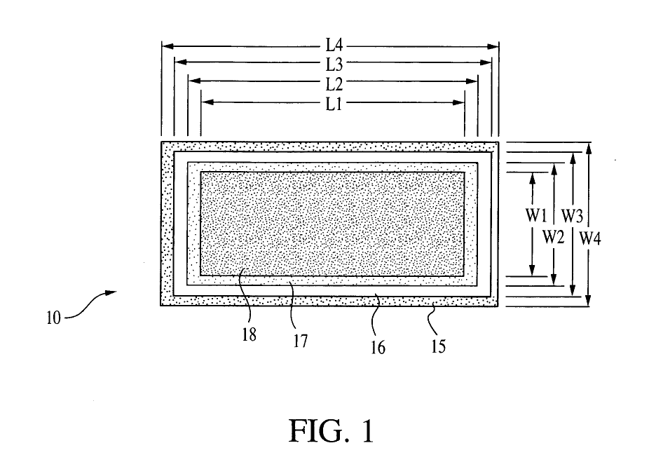

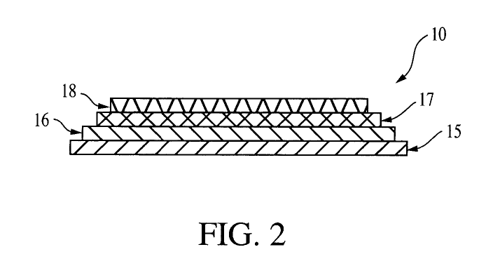

As illustrated in FIGS. 1 and 2, the basic EL lamp is a simple capacitor that generally consists of front and rear electrodes having phosphor and dielectric layers located between the electrode layers. The EL lamp 10 of the present invention comprises four distinct layers. The front electrode is a conductive substrate that is screen or rotary screen-printed or may comprise an indium tin oxide that is sputtered onto a polyester film. Generally, the front electrode comprises one or more solvents, one or more resin combinations and either a silver or carbon pigment and may comprise any clear inherently conductive polymer that is printed on a polyester substrate. The front electrode may also comprise a polyester film that is screen or rotary screen printed with an indium tin oxide ink.

The second layer 16 consists of phosphor ink that is screen printed on the front electrode and then heat cured. Phosphor is commercially available as encapsulated phosphor in various colors. The phosphor ink is screen printed on the front electrode via a wet/wet pass wherein the phosphor layer is printed and not cured followed by another print pass of phosphor before finally being heat cured. This method allows optimum packing of the phosphor particles in the phosphor layer.

The third layer is the dielectric layer 17 that is screen or rotary screen-printed on the phosphor ink. Depending upon the material used for the dielectric,,the dielectric may be briefly convection heat cured and/or finally cured via ultraviolet radiation. The printing, pre-curing with heat and final curing with UV radiation can minimize the dielectric thickness, increase the light output and lower the amperage draw. Any known EL lamp dielectric material may be utilized with the method of the invention. The dielectric may consist of an ultra violet curable diluting monofunctional, difunctional or trifunctional acrylated monomers, a polyester, acrylic, epoxy or urethane acrylated resin and a photoinitiator or a solvent based polyester, epoxy, acrylic, or vinyl resin combination. Optionally, the dielectric layer may also comprise additional materials such as flow aids.

The diluting monofunctional monomers may be present in the dielectric in the amount of about 2 to about 30 weight percent, and preferably about 3 to about 5 wt %. The difunctional acrylated monomers may be utilized in the range of about 1 to about 15 wt %. The trifunctional monomers may be present in the range of about 1 to about 10 wt %. Various resins may be utilized as the resin component of the dielectric. Among the resins that may be utilized are polyester acrylates, epoxy acrylates, acrylic acrylates, aliphatic and/or aromatic polyurethane acrylates, amine acrylates and mixtures thereof. The solvents utilized may be carbitol acetate, butyl carbitol acetate, butyl cellosolve acetate, N-propyl acetate, PM acetate, dibasic ester, chlorobenzotrifluoride or mixtures of these. Photoinitiators that may be utilized include 2-methyl-1-4(methylthio)phenyl-2-morpholinopropanone, 1, -2-benzyl-2-N,N-dimethylamino-1-(4-morpholinophenyl)-1-butanone, phenylbis (2,4,6-trimethyl benzoyl) phosphine oxide and mixtures thereof. Pigments that may be utilized include barium titanate, magnesium silicate, and/or titanium dioxide. The pigment comprises in the range of about 20 to about 80 wt % of the dielectric. Optionally, additional ingredients may be added as desired. Among these optional ingredients are silicone flow aids to facilitate good screen printability, silanes for adhesion promotion and UV antioxidants and stabilizers for long-term stability.

The top layer is the rear electrode which is preferably either a silver or carbon based solvent ink and is convection heat cured after screen-printing. Optionally, a fifth layer (not illustrated) may be added on top of the rear electrode. The optional fifth layer is the encapsulating dielectric layer and this may be screen-printed over the entire EL lamp and then UV cured. The encapsulating dielectric layer generally comprises one or more monofunctional, difunctional or trifunctional monomers, one or more acrylated resins, one or more photoinitiators and one or more flow aids. The purpose of the encapsulating dielectric layer is to protect the lamp from moisture degradation and/or potential electric shock.

As shown in FIGS. 1 and 2, the lengths and widths of the layers of the EL lamp vary. The layers are arranged in a pyramidal shape such that the front electrode has the largest dimensions and the rear electrode has the smallest dimensions. The phosphor layer and dielectric layer have smaller dimensions than the front electrode and the same or different dimensions as each other. The rear electrode has smaller dimensions than the dielectric layer. Overall, the front electrode has the largest dimensions and the rear electrode the smallest dimensions. Thus, front electrode 15 has length L4 and width W4. Phosphor layer 16 has length L3 that is shorter than L4 and width W3 that is shorter than W4. Dielectric layer 17 has length L2 that is shorter than or equal to L3 and width W2 that is shorter than or equal to W3. Rear electrode 18 has length L1 that is shorter than L2 and width W1 that is shorter than W2.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A method for printing an electroluminescent lamp comprising the steps of:
a. providing a front electrode having a length L4 and width W4;
b. printing a phosphor layer having a length L3 shorter than L4 and width W3 shorter than W4 on the front electrode;
c. curing the front electrode and phosphor layer;
d. printing a dielectric layer having a length L2 the same as or shorter than L3 and width W2 the same as or shorter than W3 on the phosphor layer;
e. curing the dielectric layer;
f. printing a rear electrode having length L1 shorter than L2 and width W1 shorter than W2 on the dielectric layer; and
g. curing the rear-electrode.

2. The method of claim 1, wherein the phosphor layer, dielectric layer and rear electrode are screen-printed.

3. The method of claim 1, comprising the further step of printing an encapsulating dielectric layer on the rear electrode.

4. The method of claim 1, wherein the phosphor layer is printed on the front electrode.

5. The method of claim 1, wherein the front electrode comprises a clear inherently conductive polymer that is printed over a polyester substrate.

6. The method of claim 1, wherein the front electrode comprises indium tin oxide that is sputter coated on a polyester substrate.

7. The method of claim 1, wherein the dielectric layer comprises one or more diluting monofunctional, difunctional or trifunctional monomer, one or more acrylated resin, one or more solvents, one or more photoinitiators, one or more flow aids and one or more pigments.

8. The method of claim 1, wherein the front electrode comprises one or more solvents, one or more resins and a silver or carbon pigment.

9. The method of claim 3, wherein the encapsulating dielectric layer comprises a monofunctional, difunctional or trifunctional monomer, an acrylated resin, one or more photoinitiators and one or more flow aids.

10. An electroluminescent lamp printed via the process of claim 1.

11. An electroluminescent lamp having a front electrode having a length L4 and width W4; a phosphor layer having a length L3 shorter than L4 and width W3 shorter than W4; a dielectric layer having a length L2 the same as or shorter than L3 and width W2 the same as or shorter than W3; and a rear electrode having length L1 shorter than L2 and width W1 shorter than W2 on the dielectric layer.

12. The electroluminescent lamp of claim 11 further comprising an encapsulating dielectric layer.
